(19) United States
(12) Patent Application Publication
(10) Pub. No.: US 2012/0026699 A1
(43) Pub. Date: Feb. 2, 2012

(54) CIRCUIT BOARD OF PORTABLE ELECTRONIC DEVICE

(75) Inventor: MING-YUAN HSU, Tu-Cheng (TW)

(73) Assignee: HON HAI PRECISION INDUSTRY CO., LTD., Tu-Cheng (TW)

(21) Appl. No.: 12/884,228

(22) Filed: Sep. 17, 2010

(30) Foreign Application Priority Data
Jul. 30, 2010 (TW) 99125440

(51) Int. Cl. H01R 12/16

(52) U.S. Cl. 361/749; 361/785

(57) ABSTRACT

A circuit board includes a main body and a connecting member mounted on the main body. The main body defines a separating groove and is divided into two segments by the separating groove, such that the main body is broken along the separating groove to separate the two segments from each other when a force is applied thereto. When the main body is broken along the separating groove to separate the two segments from each other, the connecting member electronically connects the two segments to each other.

### BACKGROUND

1. Technical Field

The present disclosure relates to circuit boards for portable electronic devices, and particularly to a circuit board capable of having different shapes.

2. Description of Related Art

Portable electronic devices, such as mobile phones, personal digital assistants (PDA), and laptop computers, are widely used. Portable electronic devices include housings and circuit boards received in the housings. The circuit boards are usually processed to be shaped similar to the shape of its housing so they can be received in the housing. Portable electronic devices can have housings in many different shapes, but may need to use similar circuits. Thus, the circuit boards of the portable electronic devices need to be mechanically processed to fit the different shapes of the different shaped housings but still be able to receive the circuits for general use in many portable electronic devices. Processing many different shaped circuit boards, which will receive similar circuits, is very inefficient and labor consuming.

Therefore, there is room for improvement within the art.

### BRIEF DESCRIPTION OF THE DRAWINGS

Many aspects of the present circuit board can be better understood with reference to the following drawings. The components in the various drawings are not necessarily drawn to scale, the emphasis instead being placed upon clearly illustrating the principles of the present circuit board. Moreover, in the drawings, like reference numerals designate corresponding parts throughout the figures.

FIG. 1 is a schematic view of a circuit board according to an exemplary embodiment, wherein the circuit board is in a first state.

FIG. 2 is a cutaway view along the line II-II shown in FIG. 1.

FIG. 3 is similar to FIG. 2, with a first connecting member attached for electronic connection.

FIG. 4 is a schematic view of the circuit board shown in FIG. 1, wherein the circuit board is in a second state, with a second connecting member attached thereto for electronic connection.

FIG. 5 is a schematic view of the circuit board shown in FIG. 1, wherein the circuit board is in a third state.

FIG. 6 is a side schematic view of a third connecting member attached to the circuit board shown in FIG. 5 for electronic connection.

### DETAILED DESCRIPTION

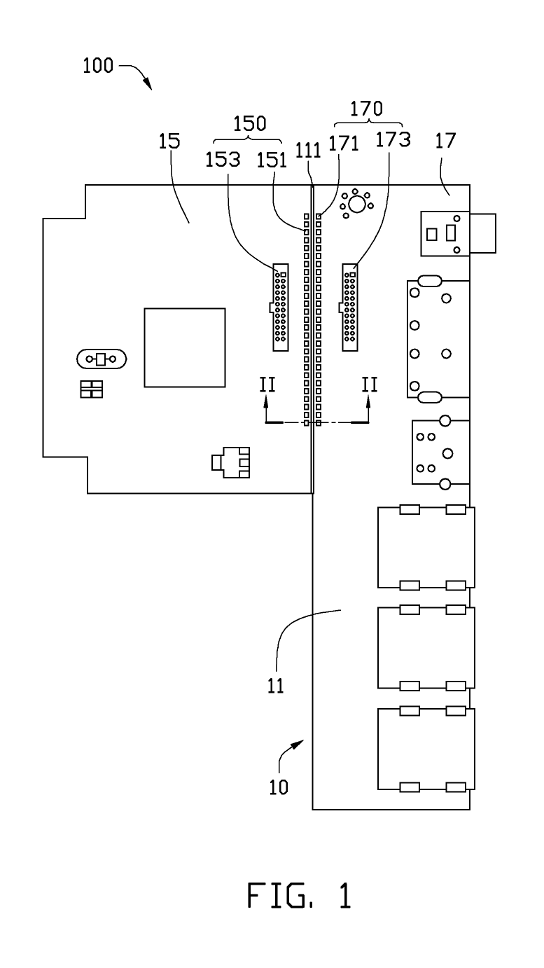

FIG. 1 shows a circuit board 100, according to an exemplary embodiment, in a first state. The circuit board 100 can be used in a portable electronic device, such as a mobile phone, a personal digital assistant (PDA), or MP3/MP4 players. The circuit board 100 includes a main body 10, which is a panel including circuits of the portable electronic device. In the first state, the circuit board 100 maintains an original shape and is received in a housing of a portable electronic device (not shown), a size similar to the original size of the main body 10.

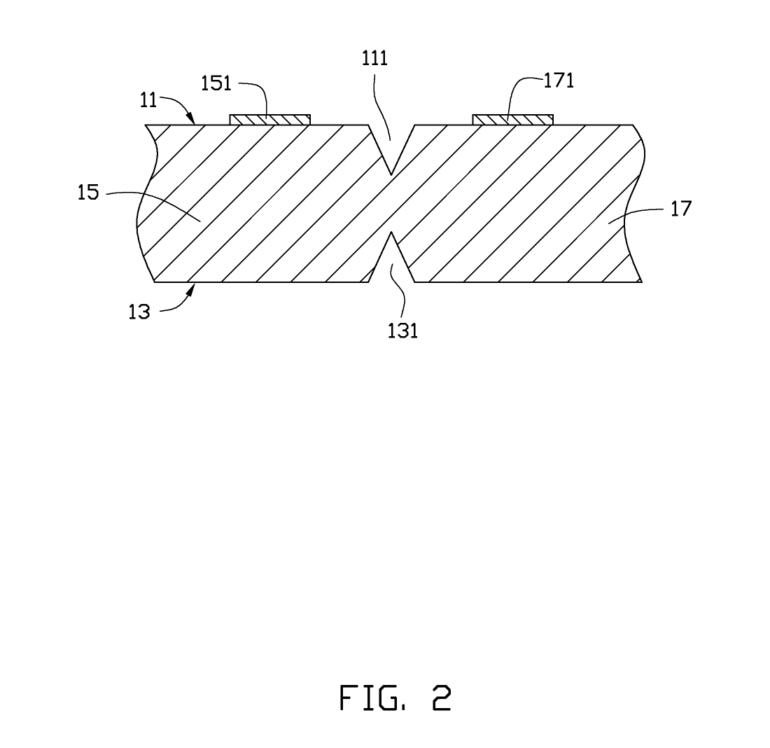

Also referring to FIG. 2, the main body 10 has a first surface 11 and a second surface 13, and the first surface 11 and the second surface 13 are opposite and parallel to each other. The main body 10 defines a first separating groove 111 in the first surface 11 and a second separating groove 131 in the second surface 13, and thus is divided into a first segment 15 and a second segment 17 by the first separating groove 111 and the second separating groove 131. The first separating groove 111 and the second separating groove 131 are aligned with each other, such that the thickness of a part of the main body 10 between the first separating groove 111 and the second separating groove 131 is less than the thicknesses of other parts of the main body 10. When a force is applied to the main body 10, the main body 10 is most likely to be broken along the first separating groove 111 and the second separating groove 131. Either one of the first separating groove 111 or the second separating groove 131 can also be omitted.

The first segment 15 includes a first electronic connection unit 150 formed thereon, and the second segment 17 includes a second electronic connection unit 170 formed thereon. The first connection unit 150 includes a number of first connectors 151 and a first interface 153. The second connection unit 170 includes a number of second connectors 171 corresponding to the first connectors 151 and a second interface 173 corresponding to the first interface 153.

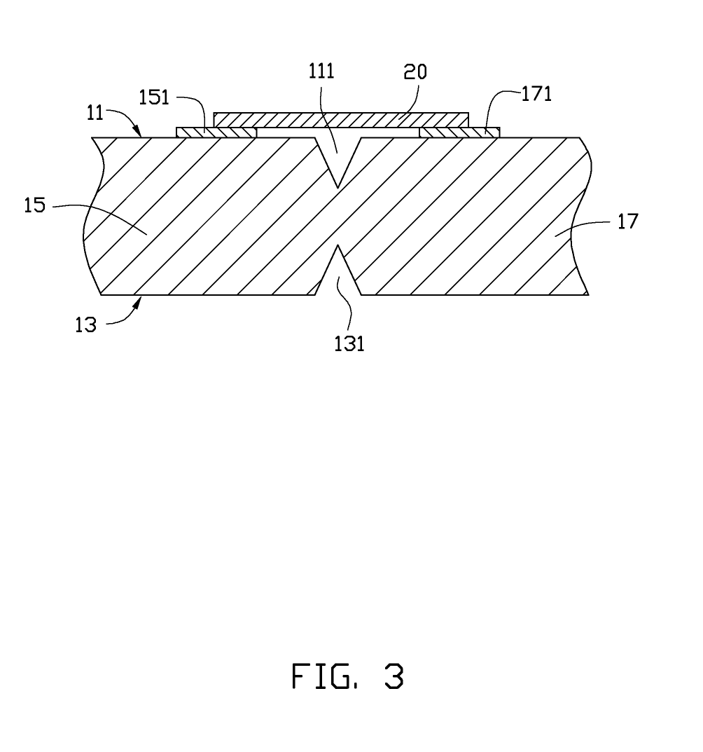

The circuit board 100 further includes a connecting member mounted on the main body 10 for electronic connection between the first segment 15 and the second segment 17. Referring to FIG. 3, in the first state, the connecting member is a number of chip resistors 20. Each chip resistor 20 is electronically connected to a first connector 151 and a second connector 171 corresponding to the first connector 151, thereby electronically connecting the first segment 15 and the second segment 17 to each other.

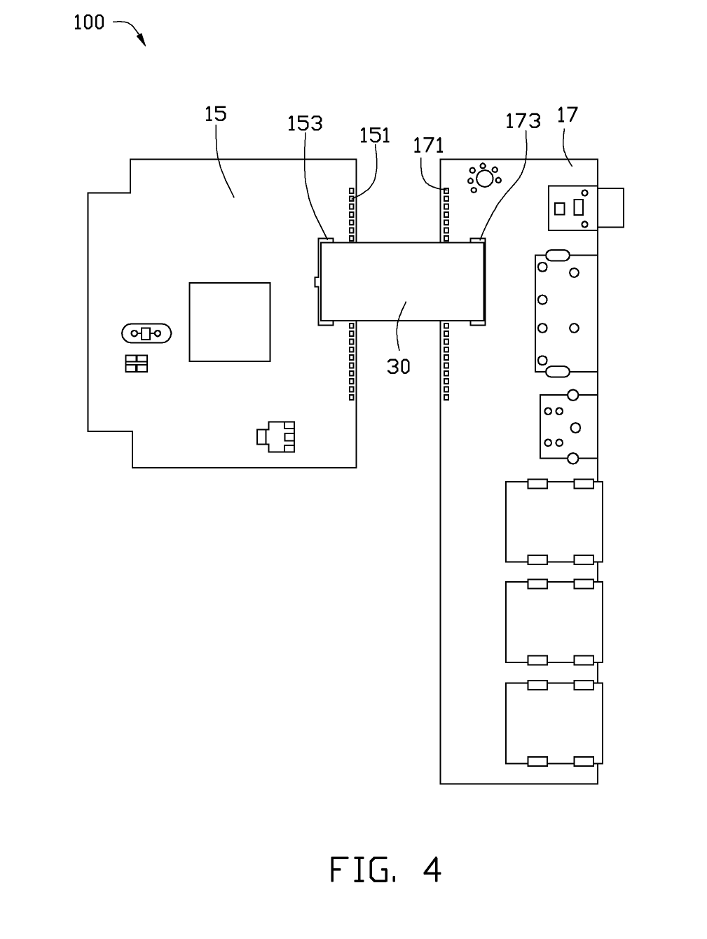

Referring to FIG. 4, when the circuit board 100 is used in a housing of a portable electronic device (not shown) in a size larger than the original size of the main body 10, the circuit board 100 is changed to a second state. In the second state, the main body 10 is broken along the first separating groove 111 and the second separating groove 131, and the first segment 15 and the second segment 17 are separated from each other. The first segment 15 and the second segment 17 are then moved away from each other for a predetermined distance and are respectively fixed in the housing.

In the second state, the connecting member is changed to a flexible printed circuit (FPC) 30. The FPC 30 is electrically connected to both the first interface 153 and the second interface 173, thereby electronically connecting the first segment 15 and the second segment 17 to each other. Thus, the first segment 15 and the second segment 17 can still cooperatively function, similar to the original main body 10. Since the first segment 15 and the second segment 17 are separated from each other, the outside size of the circuit board 100 is enlarged, and thus the circuit board 100 can be suitably received in the housing. By adjusting the distance between the first segment 15 and the second segment 17, the outside size of the circuit board 100 can be adjusted, such that the circuit board 100 can be suitably received in housings of different sizes. Additionally, the FPC 30 can facilitate the adjustment of the distance between the first segment 15 and the second segment 17, due to its flexibility.

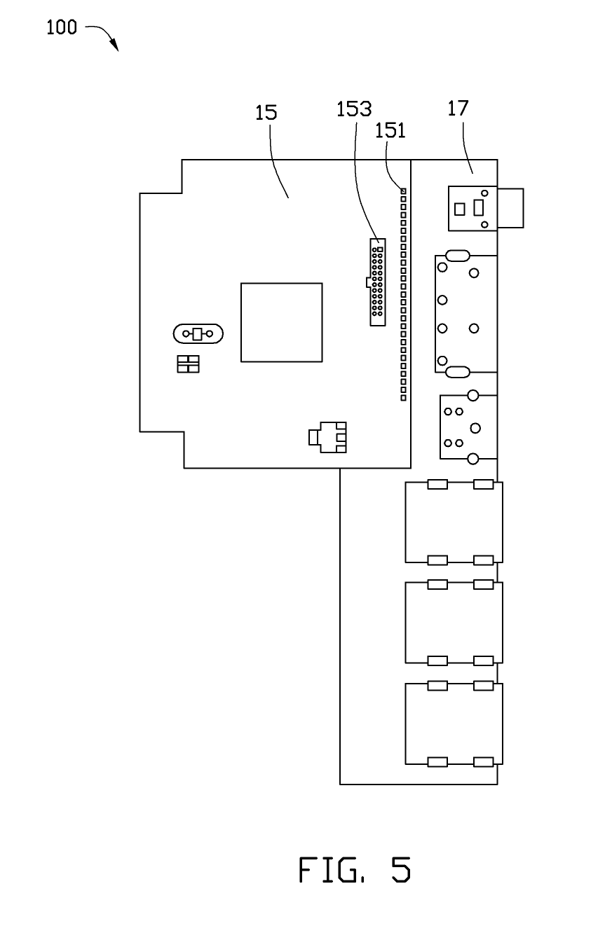

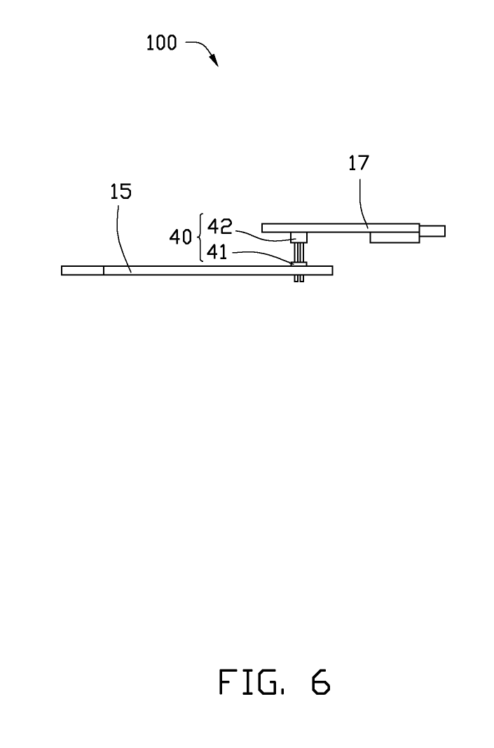

Referring to FIG. 5 and FIG. 6, when the circuit board 100 is used in a housing of a portable electronic device (not shown) in a size less than the original size of the main body 10, the circuit board 100 is changed to a third state. In the third state, the first segment 15 and the second segment 17 are separated from each other. Thus, the first segment 15 and the second segment 17 are positioned to partly superpose each other. The connecting member is changed to a connecting subassembly 40 including a plug 41 and a jack 42. The plug 41 is mounted on the first segment 15, and the jack 42 mounted on the second segment 17. The plug 41 and the jack 42 are assembled together to electronically connect the first segment 15 and the second segment 17 to each other. In other embodiments, the plug 41 and the jack 42 can also be exchanged. Finally, the first segment 15 and the second segment 17 are respectively fixed in the housing. Since the first segment 15 and the second segment 17 partly superpose each other, the outside size of the circuit board 100 is reduced, and thus the circuit board 100 can be suitably received in the housing.

The present circuit board 100 can be used in portable electronic devices having housings in different sizes. In the first state, the circuit board 100 maintains its original shape and can be received in a housing in which the size is similar to the original size of the circuit board 100. In the second and third states, the main body 10 of the circuit board 100 is broken to separate the first segment 15 and the second segment 17 from each other, and the positions of the first segment 15 and the second segment 17 are adjusted to further change the size of the circuit board 100. In this way, the circuit board 100 can be received in housings of different sizes, and does not need any additional mechanical processing operations to changing its shape. Compared with conventional circuit boards, the circuit board 100 can be easier to use in portable electronic devices having different size housings.

In the present disclosure, the chip resistor 20, the FPC 30, and the subassembly 40 can be all mounted to the main body 10. In the first and third states, the FPC 30 can also be used to electrically connect the first interface 153 to the second interface 173 to electrically connect the first segment 15 to the second segment 17. Furthermore, the main body 10 can further include more connecting members 20/30/40 and define more separating grooves dividing it into more segments, wherein each segment includes an electronic connection unit similar to the electronic connection units 150/170. In use, the main body 10 can be broken to separate the segments from each other, and thus the segments can be positioned to change the circuit board 100 to desired shape and size. The segments can be electronically connected to each other to fully function with their electronic connection units and more connecting members 20/30/40.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A circuit board, comprising:
a main body, the main body defining a separating groove and divided into two segments by the separating groove, such that the main body can be broken along the separating groove to separate the two segments from each other when a force is applied thereto; and
a connecting member mounted on the main body; wherein when the main body is broken along the separating groove to separate the two segments from each other, the connecting member electronically connects the two segments to each other.

2. The circuit board as claimed in claim 1, wherein the connecting member includes a plug mounted on one segment and a jack mounted on another segment, and the plug and the jack are assembled together to electronically connects the two segments to each other when the two segments are separated from each other.

3. The circuit board as claimed in claim 1, wherein the connecting member is a flexible printed circuit (FPC).

4. The circuit board as claimed in claim 3, wherein each segment includes an electronic connection unit, the electronic connection unit including an interface, the connecting member connected to the interfaces of both the two segments to electronically connect the two segments to each other.

5. The circuit board as claimed in claim 4, wherein the electronic connection unit further includes a plurality of connectors, and the connectors of one segment are electronically connected to the connectors of another segment before the main body is broken along the separating groove to separate the two segments from each other.

6. The circuit board as claimed in claim 5, wherein the connectors of one segment are electronically connected to the connectors of another segment by chip resistors.

7. The circuit board as claimed in claim 1, wherein the main body includes two opposite surfaces and further includes another separating groove, the two separating grooves respectively defined in the two surfaces and aligned with each other.

8. A circuit board, comprising:
a main body, the main body defining a separating groove and divided into two segments by the separating groove, the two segments being electronically connected to each other; wherein
when the circuit board is in a first state, the two segments are maintained together without being broken; when the circuit board is in a second state, the main body is broken along the separating groove to separate the two segments from each other, and the two segments are moved away from each other; when the circuit board is in a third state, the main body is broken along the separating groove to separate the two segments from each other, and the two segments are positioned to partly superpose each other.

9. The circuit board as claimed in claim 8, wherein the main body includes two opposite surfaces and further includes another separating groove, the two separating grooves respectively defined in the two surfaces and aligned with each other.

10. The circuit board as claimed in claim 8, wherein the two segments are electronically connected to each other by a flexible printed circuit (FPC) in the second state of the circuit board.

11. The circuit board as claimed in claim 10, wherein each segment includes an electronic connection unit, the electronic connection unit includes a plurality of connectors, and the connectors of one segment are electronically connected to the connectors of another segment in the first state of the circuit board.

12. The circuit board as claimed in claim 11, wherein the connectors of one segment are electronically connected to the connectors of another segment by chip resistors.

13. The circuit board as claimed in claim 12, wherein the electronic connection unit further includes an interface, the FPC connected to the interfaces of both the two segments to electronically connect the two segments to each other in the second state of the circuit board.

14. The circuit board as claimed in claim 8, wherein the two segments are electronically connected to each other by a plug mounted on one segment and a jack mounted on another segment in the third state of the circuit board.
